(19) United States
(12) Patent Application Publication
(10) Pub. No.: US 2006/0255514 A1
(43) Pub. Date: Nov. 16, 2006

(54) Method of scrap reduction in a mold

(75) Inventors: Roy N. Krohn, York, PA (US); David A. Kesselman, York, PA (US)

Correspondence Address: VENABLE LLP, P.O. BOX 34385, WASHINGTON, DC, 20043-9998, US

(73) Assignee: GRAHAM PACKAGING COMPANY, L.P., York, PA (US)

(21) Appl. No.: 11/125,112

(22) Filed: May 10, 2005

(51) Int. Cl. B29C 49/00

(52) U.S. Cl. 264/536; 425/522; 264/540

(57) ABSTRACT

A method of scrap reduction in a wheel blow-molding device includes the steps of upwardly extruding a parison and gripping a top end of the parison in a portion of a first mold coupled to the wheel blow-molding device. Then, the parison is enclosed in a second mold coupled to the wheel blow-molding device that follows the first mold. Next, the parison is cut such that a gap in the parison is created.

### BACKGROUND OF THE INVENTION

1. Field of the Invention

The present invention relates generally to scrap reduction in blow molding, and more particularly to scrap reduction in a wheel blow molding device.

2. Related Art

Wheel blow molding devices typically have of a series of molds arranged on a wheel revolving around a central pivot. As an empty mold approaches an extruded parison, it closes around the parison, pinching off or cutting the parison. Once the mold is closed, a blow needle is inserted into the mold to inflate the parison into the mold. As the mold continues to revolve around the pivot, the product in the mold cools and hardens, and falls out when the mold opens. The process repeats for the series of molds arranged on the wheel.

When the product or container to be formed is smaller than the mold, a large amount of scrap, or flash, is created because the parison is traditionally as long as the mold.

What is needed then is a method that reduces the scrap generated in a wheel blow molding device when the product being produced is significantly shorter than the mold is long.

### BRIEF SUMMARY OF THE INVENTION

Embodiments of the present invention provide a mold for and a method of reducing scrap production in a wheel blow-molding device. An end of an extruded parison portion is gripped by a portion of a leading mold, while the remainder of the parison portion is enclosed in a following mold. The parison portion is cut at a length appropriate for the container being molded, instead of leaving the parison portion as long as the mold body. The mold halves may be in contact with each other in the mold portion where no parts of the container are to be formed.

In an exemplary embodiment, the present invention may be a method of scrap reduction in a wheel blow-molding device, comprising: upwardly extruding a parison; gripping a top end of the parison in a portion of a first mold coupled to the wheel blow-molding device; enclosing the parison in a second mold coupled to the wheel blow-molding device and following the first mold; and cutting the parison, such that a gap in the parison is created.

An another exemplary embodiment, the present invention may be a mold for scrap reduction in a wheel blow-molding device, the mold comprising: a first half and a second half, each half having a rotation direction and a transverse direction perpendicular to the rotation direction, each half having: a cavity, adapted to receive a first parison; a parison gap region adjacent to the cavity in the rotation direction; and a parison gripping region adjacent to the parison gap region, adapted to grip an end of a second parison; wherein when the first and second mold halves are coupled, the parison gap regions of the first and second mold halves are in contact with one another and are adapted to prevent the first parison from being blown into the parison gap region.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts an exemplary embodiment of a method according to the present invention;

FIG. 2 depicts an exemplary embodiment of a mold and a wheel blow molding device according to the present invention;

FIG. 3 depicts an exemplary embodiment of a parison extrusion device according to the present invention; and

FIG. 4 depicts an exemplary embodiment of the parison extrusion device shown in FIG. 3 cutting a parison, according to the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

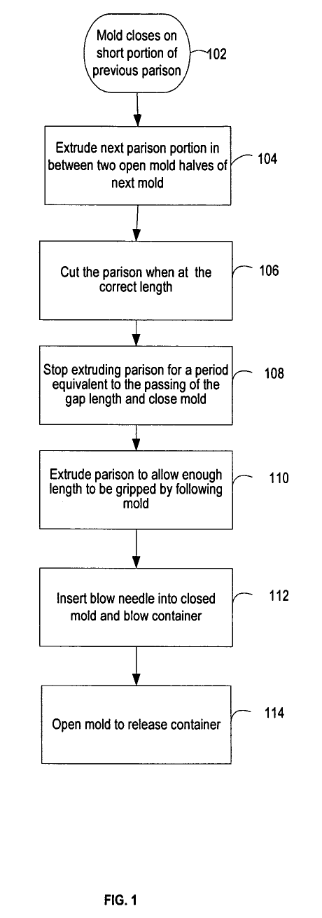

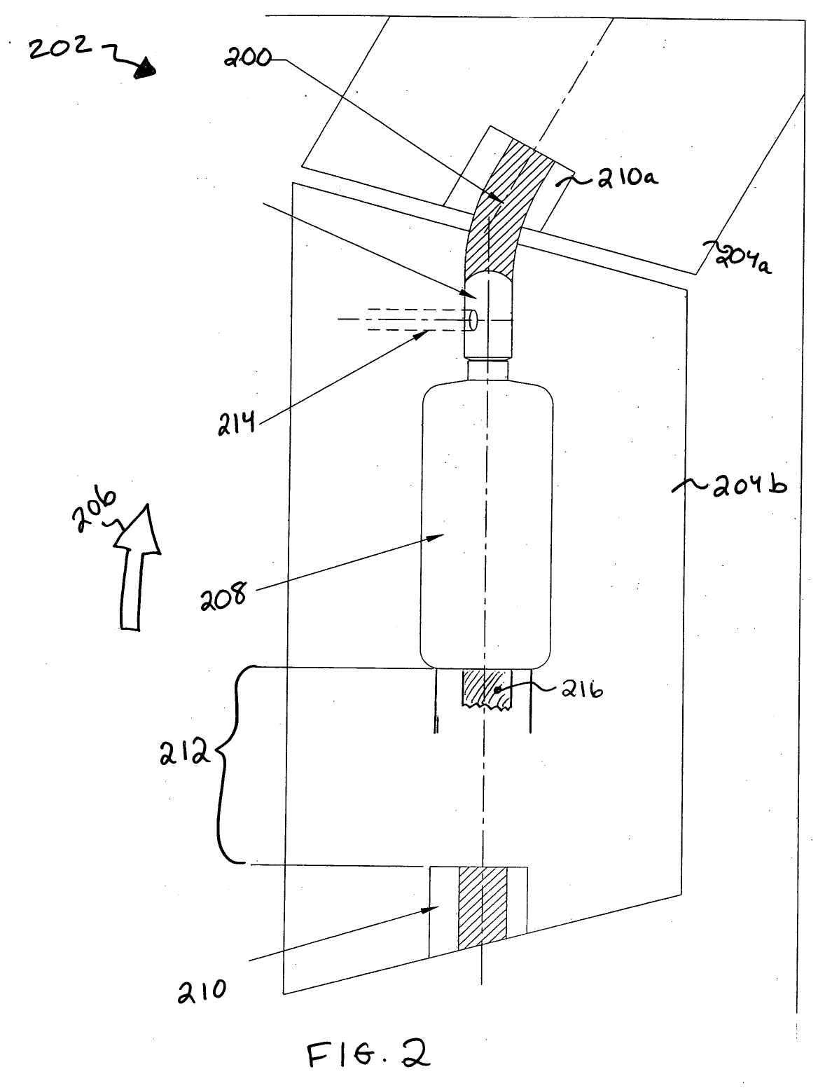

FIG. 1 is a flowchart illustrating an exemplary embodiment of a method of the present invention. FIG. 2 illustrates an exemplary embodiment of an apparatus 202 used to execute the method. The apparatus 202 comprises a series of molds 204a, 204b (collectively 204) disposed radially around a central pivot in a wheel. A parison extrusion apparatus (not shown) is disposed in proximity to the side of the wheel where the molds 204 are moving upward away from the floor (as indicated by arrow 206), so that extruded parison (e.g., 200) may be inserted into or enclosed by the molds. The use of the term “upward” is not meant to limit the invention, but may instead be a direction relative to the turning of the wheel.

The method of the invention may occur cyclically as any one particular mold completes a revolution about the central pivot. In block 102, mold 204a is closing on a previously extruded parison portion and grips a short portion of a next parison portion in a parison gripping portion 210a. In block 104, as the wheel continues to rotate, mold 204a pulls the next parison portion upward, e.g., in the direction of arrow 206, and the next parison portion is extruded in a generally upward direction between the two halves of the next mold 204b. When the parison portion between the mold halves of mold 204b covers the length of the cavity 208, the parison is cut, in block 106. The parison may extend slightly beyond the end of the cavity to create a tail flash 216. In block 108, extrusion of the parison stops for a period of time equivalent to the passing of the gap region 212, while the mold 204b closes on the parison portion. In block 110, extrusion of the parison resumes at a time sufficient to allow a short portion of the newly extruded parison to be gripped in the parison gripping portion 210 of closing mold 204b. A blow needle is inserted into mold 204b and a container is blow-molded into the mold 204b in block 112. As the mold 204b completes a revolution, the mold 204b opens and the container falls or is ejected from the mold in block 114. The process repeats as mold 204b closes over a new parison portion and begins a new revolution.

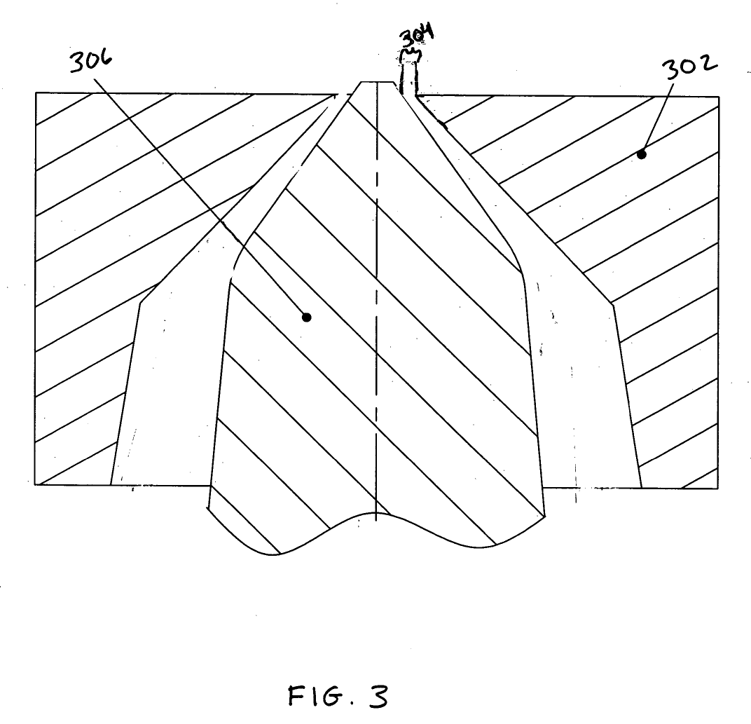

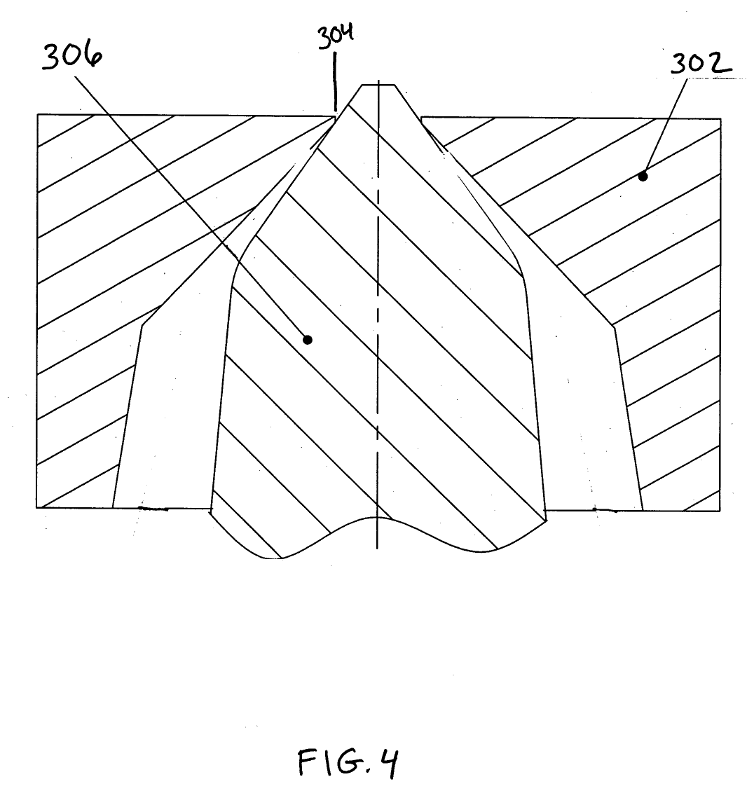

FIGS. 3 and 4 illustrate an exemplary parison extrusion apparatus in an extruding and a cutting position, respectively. The parison extrusion apparatus includes a bushing 302 forming a die gap 304, and a die pin 306. The position of the die pin 306 in the die gap 304 determines the thickness of the parison by controlling the size of the opening through which the parison is extruded. As FIG. 4 shows, the parison may be cut by closing the die gap 304 completely. In an exemplary embodiment, the die pin 306 moves upward very rapidly to make contact with the bushing 302 when cutting the parison, but does not distort the bushing orifice. The internal angular relationship between the internal sides of the bushing 302 and the sides of the die pin 306 may vary from what is depicted in the figures.

While the method described above can be practiced with conventional molds for wheel blow molding devices, the best results in scrap savings may be achieved with a modified mold as seen in FIG. 2. In an exemplary embodiment, a mold 204 for scrap reduction in a wheel blow-molding device includes two halves. When the two halves are joined, they form a cavity 208 to receive a parison. Following the cavity, from the perspective of the direction of motion, is a parison gap region 212. In the parison gap region 212, the two halves of the mold are in substantial contact with each other. The parison gap region 212 prevents the creation of scrap when the parison in the mold is blown. In conventional molds, a thin cavity is needed in this portion of the mold to accommodate the scrap of the parison. In an exemplary embodiment, the parison gap region 212 may include a small tail flash region 216 directly adjacent to the cavity 208 to allow the formation of a tail flash on the container. The base of the mold 204 includes a parison gripper 210 adjacent to the parison gap region 212. Parison gripper 210 is adapted to grip the end of a parison. One mold half further contains an opening 214 adapted to receive a blow needle for introducing blow air into the mold.

By providing parison gap region 212 and cutting the parison as discussed above, a significant reduction in parison waste can be achieved. By properly coordinating the cutting of the parison and the period for which no parison is extruded, little or no parison is provided to parison gap region 212, thus reducing parison waste.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A method of scrap reduction in a wheel blow-molding device, comprising:
upwardly extruding a parison;
gripping a top end of said parison in a portion of a first mold coupled to the wheel blow-molding device;
enclosing said parison in a second mold coupled to the wheel blow-molding device and following said first mold; and
cutting said parison, such that a gap in said parison is created.

2. The method of claim 1, wherein said parison is upwardly extruded through a die gap between a bushing and a die pin.

3. The method of claim 2, wherein said cutting comprises:
closing said die gap between said bushing and said die pin to stop said extruding.

4. The method of claim 1, further comprising:
upwardly extruding a second portion of the parison, said second portion having a top end beginning where said parison was cut; and
gripping said top end of said second parison in a portion of said second mold.

5. The method of claim 4, wherein said parison is upwardly extruded through a die gap between a bushing and a die pin.

6. The method of claim 5, wherein said cutting comprises:
closing said die gap between said bushing and said die pin to stop said extruding.

7. The method of claim 1, further comprising:
extruding said parison in said second mold.

8. The method of claim 1, wherein the cutting of said parison is performed by said second mold when said second mold closes to enclose said parison.

9. A mold for scrap reduction in a wheel blow-molding device, the mold comprising:
a first half and a second half, each half having a rotation direction and a transverse direction perpendicular to the rotation direction, each half having:
a cavity, adapted to receive a first parison;
a parison gap region adjacent to said cavity in the rotation direction; and
a parison gripping region adjacent to said parison gap region, adapted to grip an end of a second parison;
wherein when said first and second mold halves are coupled, said parison gap regions of said first and second mold halves are in contact with one another and are adapted to prevent said first parison from being blown into said parison gap region.

10. The mold of claim 9, wherein said parison gap region prevents the creation of scrap when said first parison is blown.

11. The mold of claim 9, further comprising an opening adapted to receive a blow needle.

12. The mold of claim 9, wherein said parison gap regions of said first and second mold halves are in contact with one another along an entire width of the mold halves along the transverse direction.

13. The mold of claim 9, wherein at least one of the first and second mold halves comprises a tail flash region between said cavity and said parison gap region.

14. The mold of claim 13, wherein each of the first and second mold halves comprises a tail flash region between said cavity and said parison gap region.
